(19) United States
(12) Patent Application Publication
(10) Pub. No.: US 2021/0317293 A1
(43) Pub. Date: Oct. 14, 2021

(54) ACTIVATING VULCANISING COMPOSITION

(71) Applicant: SOCIETE INDUSTRIELLE LIEGEOISE DES OXYDES, Engis (BE)

(72) Inventor: Olivier ROUMACHE, Engis (BE)

(21) Appl. No.: 17/229,667

(22) Filed: Apr. 13, 2021

(30) Foreign Application Priority Data
Apr. 14, 2020 (BE) BE2020/05243

(51) Int. Cl. C08L 23/16; C08K 3/22; C08K 3/26

(52) U.S. Cl. CPC C08L 23/16; C08K 3/22; C08K 2003/265; C08K 2003/2296; C08K 3/26

(57) ABSTRACT

An activating composition for use in vulcanisation includes based on the total weight of the activating composition: 20 to 80% by weight of at least one vulcanisation activator [activator (V)]; 10 to 40% by weight of at least one wax selected from the group constituted of paraffin waxes, microcrystalline waxes, polyolefin waxes, Fischer-Tropsch waxes, oxidised Fischer-Tropsch waxes, their derivatives and mixtures thereof; 10 to 40% by weight of at least one inorganic filler. A method is for manufacturing the activating composition.

### FIELD OF THE INVENTION

The present invention relates to the field of polymer vulcanisation, more specifically in the field of activating vulcanising compositions.

### STATE OF THE ART

Vulcanisation is a cross-linking reaction occurring when a vulcanisable polymer is brought together with a vulcanising agent (generally sulphur) and thermal energy. The latter is necessary for establishing chemical bonds between the vulcanising agent and the reactive sites of the molecular chains of the polymer forming a three-dimensional network.

Once the polymer is vulcanised, this has specific mechanical and elastic properties, suitable for being used in various fields of application, for example in tyres.

In order to activate the vulcanisation reaction between the polymer and the vulcanising agent, it is known to use a vulcanising activator such as an oxygenated divalent metal compound of which the most commonly used is zinc oxide, ZnO and/or zinc hydroxycarbonate.

It is presumed that, the activator is combined with stearic acid to generate an active complex. The latter thus allows to activate the sulphurous compound intervening in the vulcanisation reaction and to reduce the vulcanisation time.

The document entitled, “Activators in Accelerate Sulfur Vulcanization” (Geert Heideman, Rabin N. Datta, Jacques W. M. Noordermeer, and Ben van Baarle, published in “Rubber Chemistry and Technology”, July 2004; volume 77, number 3, pages 512-541) discusses and brings together most of the relevant publications which deal with vulcanisation.

Generally, a polymer (e.g. natural rubber) is vulcanised with sulphur and ZnO at a rate of 5 to 8 phr of ZnO. “phr” is a unit of measurement which allows to express the number of parts of a component of a composition to be vulcanised with respect to 100 polymer parts expressed by weight. Therefore, a phr of ZnO is the equivalent of one part of ZnO per 100 parts of polymer expressed by weight.

For economic, and environmental protection reasons, it is recommended to reduce the use of the vulcanisation agent as much as possible (most often ZnO) in the vulcanisation method. Indeed, zinc oxide is an expensive compound which is damaging to the environment. There is therefore a continuous need to be able to reduce the quantity of ZnO used in vulcanisation methods. There are solutions which consist of replacing the vulcanisation agent (most often ZnO) with activating compositions comprising reduced quantities of vulcanisation agent.

Document U.S. Pat. No. 6,046,260 A describes the use of zinc oxide dispersions in order to improve the incorporation of zinc oxide in elastomers such as natural rubbers in order to activate the curing or the vulcanisation of these. The zinc oxide dispersion described in this document comprises at least 40% by weight of zinc oxide and at least 5% by weight of a binding agent selected from the group constituted of asphalt and tackifying terpenes. It has been demonstrated that such dispersions comprising 80% of zinc oxide can be incorporated more rapidly in rubber and allow to obtain a better curing state and better physical properties of a powder constituted of 100% of ZnO.

Document U.S. Pat. No. 6,277,901 B1 discloses additives for rubber adapted to be incorporated and dispersed in rubber. The composition comprises at least one additive substance in the form of solid powder which could be a vulcanisation additive coated in a dispersant. More specifically, to reduce the quantity of ZnO, this document discloses that ZnO having a specific raised BET surface (42 m²/g) is used. The latter is coated with a coating formed of a mixture of wool fat/fatty acid ester used in a vulcanisation method.

Document US 2008/0015286 A1 describes a composition allowing to reduce the quantity of divalent metal (curing activator, such as ZnO) while improving the physical properties of the product resulting from the cure reaction. The results described in this document are achieved by the microencapsulation of active components such as ZnO, Zn stearate and/or stearic acid in order to avoid the “parasitic” reaction of the zinc stearate with hydroxyl silica groups used as filler in the composition.

However, the strategies of the state of the art to reduce the quantities of activation agent (most often, ZnO) suffer from disadvantages. For example, in certain cases, the additives used can be relatively cheap and/or do not provide a sufficient versatility to the vulcanisation method and/or they can potentially cause parasitic reactions during the vulcanisation reaction. In addition, the strategies described above can also prove to be very complex to implement.

There is therefore a real need to provide an activating composition for use in a vulcanisation method, allowing to resolve at least partially the disadvantages described above.

### SUMMARY OF THE INVENTION

The inventors have surprisingly described that it is possible to provide an activating composition for use in a vulcanisation method, allowing to resolve the disadvantages at least partially.

An activating composition [composition (A)] is therefore proposed for use in a vulcanisation method, comprising based on the total weight of said composition (A):
20 to 80% by weight of at least one vulcanisation activator [activator (V)];
10 to 40% by weight of at least one wax selected from the group constituted of paraffin waxes, microcrystalline waxes, polyolefin waxes, Fischer-Tropsch waxes, oxidised Fischer-Tropsch waxes, their derivatives and mixtures thereof;
10 to 40% by weight of at least one inorganic filler (filler (I)] or carbon black.

Another aspect of the present invention relates to a method for producing said composition (A).

The present invention also relates to a method for vulcanising a vulcanisable composition [composition (C)] comprising, with respect to the total weight of the composition (C), steps of:
providing said composition (C) comprising:
a mixture of at least one vulcanisable polymer (polymer (V)] with between 2 and 10 parts by weight of said composition (A) with respect to 100 parts by weight of said polymer (V),

and with 0.2 to 15 parts by weight of at least one vulcanising agent [agent (V)] with respect to 100 parts by weight of said polymer (V) to form said composition (C),
a heating of said composition (C) to a sufficient temperature to obtain a vulcanised composition.

A last aspect of the present invention relates to a vulcanised composition obtained by the vulcanisation method according to the invention.

### DETAILED DESCRIPTION

According to the present invention, the term “comprising” is inclusive and open and does not exclude the addition of elements which would not be listed, of composition or steps of the method.

Composition (A)

As explained above, the present invention relates to an activating composition (A) [composition (A)] for use in a vulcanisation method.

The vulcanisation methods are known to a person skilled in the art. Generally, a vulcanisation reaction is a chemical cross-linking reaction when a vulcanisable polymer (like for example, natural rubber) is brought together with a vulcanising agent (generally, sulphur) and thermal energy.

Preferably, said composition (A) is suitable for use in a method for vulcanising a vulcanisable composition [composition (C)] comprising a polymer (V) when less than 10 parts by weight, more preferably less than 8 parts by weight, even more preferably less than 6 parts by weight of said composition (A) are comprised in the composition (C) with respect to 100 parts by weight of the polymer (V).

Activator (V)

Said composition (A) comprises based on the total weight of said composition (A), at least 20% and at most 80% by weight of at least one vulcanisation activator [activator (V)].

Generally, the activator (V) when it is used in a vulcanisation method interacts with the vulcanising agent (generally, sulphur) so as to activate the vulcanisation reaction, i.e. to increase the speed of the vulcanisation reaction. In the case of the present invention, the composition (A) can replace the vulcanisation activator usually used in a vulcanisation method. The low content of activator (V) in the composition (A) allow to reduce the general toxicity of the vulcanisation method, its price and its damaging effect on the environment. Although the content of activator (V) is reduced, it has surprisingly been observed that the use of the composition (A) in a method for vulcanising a polymer allows to obtain a vulcanised polymer of which the mechanical properties are similar or improved with respect to an activating composition, wherein the activator (V) would represent more than 80% by weight of the activating composition. The effects mentioned above are all the truer when the composition (A) is used at a low concentration in a method for vulcanising a vulcanisable composition.

The activator (V) according to the present invention relates to any type of compound allowing to interact with a vulcanising agent such as sulphur, so as to activate the vulcanisation reaction. Examples of activator (V) include without being limited to it: zinc oxide, calcium oxide, zinc hydroxycarbonate, zinc hydroxide, MgO, CdO, CuO, PbO, NiO and mixtures thereof.

The activator (V) is preferably selected from the group constituted of oxygenated metal compounds such as oxides, peroxides or metal hydroxides or metal hydroxycarbonates.

Advantageously, the activator (V) is selected from the group of oxides, peroxides, transition metal hydroxides or hydroxycarbonates, alkaline metals or alkaline earth metals.

Preferably, the activator (V) is selected from the group constituted of zinc oxide, zinc hydroxide, zinc hydroxycarbonate and mixtures thereof or their derivatives, even more preferably the activator (V) is a mixture of zinc oxide and zinc hydroxide or even more preferably the activator (V) is a mixture of zinc oxide, zinc hydroxide and zinc hydroxycarbonate.

Advantageously, the composition (A) can comprise at most 70%, preferably at most 60%, more preferably at most 50%, even more preferably at most 40%, even more preferably at most 35% by weight of said activator (V) with respect of the total weight of said composition (A).

Said composition (A) contains at least 20%, preferably at least 22%, more preferably at least 23%, even more preferably at least 25% by weight of said activator (V) with respect to the total weight of said composition (A).

In a preferred embodiment, said composition (A) comprises 20% to 70% by weight, preferably 20% to 60% by weight, more preferably 20% to 50% by weight, even more preferably 20% to 40%, even more preferably 22% to 40%, even more preferably 23% to 40%, even more preferably 25% to 35% by weight of said activator (V) with respect to the total weight of said composition (A).

Said activator (V) can be present in the form of particles.

The composition (A) according to the present invention allows to use activators (V) have a wide range of specific surface area, which allows to enhance activators (V) having a low specific surface area and activators (V) having a high specific surface area, which contributes to the versatility of the composition (A).

Generally, the activator (V) can have a specific BET surface area of at least 1 m²/g, preferably of at least 2 m²/g, more preferably of at least 3 m²/g, even more preferably of at least 4 m²/g, even more preferably of at least 5 m²/g, even more preferably of at least 10 m²/g, even more preferably of at least 15 m²/g, even more preferably of at least 20 m²/g, even more preferably of at least 25 m²/g, even more preferably of at least 30 m²/g, even more preferably of at least 35 m²/g, even more preferably of at least 40 m²/g. The activator (V) can preferably have a specific BET surface area of at most 100 m²/g, more preferably of at most 90 m²/g, even more preferably of at most 80 m²/g, even more preferably of at most 70 m²/g, even more preferably of at most 60 m²/g, even more preferably of at most 55 m²/g.

In a preferable embodiment, the activator (V) has a specific BET surface area comprised between 1 and 100 m²/g, preferably between 2 and 90 m²/g, more preferably between 3 and 80 m²/g, more preferably between 4 and 70 m²/g, more preferably between 5 and 60 m²/g.

In a particular embodiment, the activator (V) can have a specific BET surface area comprised between 15 and 100 m²/g, preferably between 20 and 100 m²/g, more preferably between 25 and 90 m²/g, more preferably between 30 and 80 m²/g, more preferably between 30 and 70 m²/g, even more preferably between 30 and 60 m²/g, even more preferably between 40 and 60 m²/g.

In an alternative embodiment, the activator (V) can have a specific BET surface area comprised between 1 and 15 m²/g, preferably between 1 and 10 m²/g, more preferably between 2 and 10 m²/g, more preferably between 3 and 10 m²/g, more preferably between 4 and 10 m²/g, even more preferably between 5 and 10 m²/g.

In the scope of the present invention, the specific BET surface area is measured by measuring by adsorption manometry with a helium/nitrogen mixture (70/30) and calculated according to the BET (Brunauer-Emmett-Taylor) method, after degassing at 150° C. for at least 1 hour.

Said activator (V) can have an average diameter D₅₀ of at least 100 nm, preferably at least 200 nm, more preferably at least 250 nm, even more preferably at least 300 nm. Said activator (V) can have an average diameter D₅₀ of at most 1000 nm, preferably of at most 800 nm, more preferably at most 600 nm, more preferably of at most 500 nm.

In a particular embodiment, said activator (V) can have an average diameter D₅₀ comprised between 100 and 1000 nm, preferably between 200 and 800 nm, preferably between 250 and 600 nm, more preferably between 300 and 500 nm.

In another embodiment, the activators can be of nanometric size or have an average diameter D₅₀ of less than 100 nm, preferably of less than 50 nm, more preferably of less than 25 nm, even more preferably of less than 10 nm.

The notation Dₓ represents a diameter, expressed in μm, with respect to which X % by volume of the total volume of the particles measured is composed of smaller particles. In the scope of the present invention, all the grain size measurements of D₅₀, are laser grain size measurements taken in an aqueous dispersant. The laser grain size measurement can be taken after ultrasonication, to deagglomerate the particles possible agglomerated.

In a preferred embodiment, said composition (A) comprises 20% to 70% by weight, preferably 20% to 60% by weight, more preferably 20% to 50% by weight, even more preferably 20% to 40%, even more preferably 22% to 40%, even more preferably 23% to 40%, even more preferably 25% to 35% by weight of said activator (V) with respect to the total weight of said composition (A), the activator (V) being a mixture of zinc oxide and zinc hydroxide and has an average diameter D₅₀ comprised between 300 and 500 nm, and a specific BET surface area comprised between 5 and 60 m²/g.

Wax

The composition (A) also comprises 10% to 40% by weight of at least one wax selected from the group constituted of paraffin waxes, microcrystalline waxes, polyolefin waxes, Fischer-Tropsch waxes, oxidised Fischer-Tropsch waxes, their derivatives and mixtures thereof.

Generally, the microcrystalline waxes are derived from oil and refined from slack wax to split and separate the microcrystalline fraction.

Polyolefin waxes include without being limited thereto, polyethylene waxes, polypropylene waxes, polyethylene-polypropylene copolymer waxes and mixtures thereof. Polyethylene and polypropylene waxes can generally have an average molecular mass by number (Mn) comprised between 1000 and 10000 g/mol. Polyethylene waxes include, without being limited thereto, polyethylene homopolymer waxes, thermally cracked polyethylene waxes, high-density polyethylene waxes, low-density polyethylene waxes and mixtures thereof.

Fischer-Tropsch waxes are conventionally synthetised by the Fischer-Tropsch method. These synthetic waxes are manufactured in a controlled environment by using carbon monoxide and hydrogen as a raw material, mainly producing saturated hydrocarbon chains.

Said at least one wax of the present invention allows to act as binding agent for the different components of the composition (A). In addition, during a vulcanisation method, an apolar oily phase is often added to the vulcanisable polymer (for example, paraffin oils). The waxes used in the scope of the present invention also tend to be apolar, which facilitates accounting for the composition (A) with the oily phase. In addition, the waxes used in the scope of the present invention have a low or zero unsaturation percentage. The unsaturations could react during the vulcanisation method, it is therefore clearly advantageous to use waxes such as defined above. Indeed, their low or zero unsaturation rate allows to limit the secondary reactions during the vulcanisation and to better control the nature and/or the properties of the cross-linked polymer obtained after vulcanisation. Said at least one wax also has a low toxicity and a low reactivity, there is therefore not much chance such that these waxes interact negatively with the activator (V) before and during the vulcanisation method.

Advantageously, said wax has a viscosity of at least 3 cPs, preferably at least 5 cPs, more preferably at least 10 cPs, measured according to the standard ASTM D3236 at 149° C. Said wax can have a viscosity of at most 2000 cPs, preferably at most 1800 cPs, more preferably at most 1600 cPs, even more preferably at most 1500 cPs, even more preferably at most 1300 cPs, even more preferably at most 1200 cPs measured according to the standard ASTM D3236 at 149° C. More advantageously, said wax can have a viscosity comprised between 3 cPs and 2000 cPs, preferably comprised between 5 cPs and 1800 cPs, more preferably comprised between 10 cPs and 1600 cPs, even more preferably comprised between 10 cPs and 1500 cPs, even more preferably comprised between 10 cPs and 1300 cPs, even more preferably comprised between 10 cPs and 1200 cPs measured according to the standard ASTM D3236 at 149° C.

In an alternative embodiment, said wax has a viscosity of at most 50 cPs, preferably at most 40 cPs, more preferably at most 30 cPs, even more preferably at most 20 cPs, measured according to the standard ASTM D3236 at 149° C. Said wax can have a viscosity comprised between 3 cPs and 50 cPs, preferably between 5 cPs and 40 cPs, more preferably between 10 cPs and 30 cPs, even more preferably between 10 cPs and 20 cPs, measured according to the standard ASTM D3236 at 149° C.

In another particular embodiment, said wax has a viscosity of at least 500 cPs, preferably at least 700 cPs, more preferably at least 900 cPs, even more preferably at least 1000 cPs, measured according to the standard ASTM D3236 at 149° C. Said wax can have a viscosity comprised between 500 cPs and 2000 cPs, preferably between 700 cPs and 1800 cPs, more preferably between 900 cPs and 1600 cPs, even more preferably between 1000 cPs and 1500 cPs, even more preferably between 1000 cPs and 1300 cPs, even more preferably between 1000 cPs and 1200 cPs measured according to the standard ASTM D3236 at 149° C.

Advantageously, said wax is solid at ambient temperature. Preferably, said wax can have a dropping point of at least 25° C., preferably of at least 35° C., preferably of at least 50° C., preferably of at least 80° C., more preferably of at least 100° C., even more preferably of at least 105° C., measured according to the standard ASTM D3954. Said wax can have a dropping point of at most 130° C., preferably of at most 125° C., more preferably of at most 123° C., even more preferably of at most 120° C., measured according to the standard ASTM D3954.

In a preferred embodiment, said wax can have a dropping point comprised between 25° C. and 130° C., preferably between 35° C. and 125° C., preferably between 50° C. and 125° C., more preferably between 100° C. and 123° C., even more preferably between 107° C. and 120° C., measured according to the standard ASTM D3954.

The composition (A) comprises at least 10%, preferably at least 15%, more preferably at least 20%, even more preferably at least 25%, even more preferably at least 30% by weight of said at least one wax with respect to the total weight of the composition (A).

The composition (A) comprises at most 40% preferably at most 38%, more preferably at most 36%, even more preferably at most 35%, even more preferably at most 30% by weight of said at least one wax, with respect to the total weight of the composition (A).

In a preferable embodiment, the composition (A) comprises between 15% and 40% by weight, preferably between 20% and 38% by weight, more preferably between 25% and 36% by weight, even more preferably between 30% and 35% by weight of said at least one wax, with respect to the total weight of the composition (A).

In a preferred embodiment, the composition (A) comprises between 15% and 40% by weight, preferably between 20% and 38% by weight, more preferably between 25% and 36% by weight, even more preferably between 30% and 35% by weight of said at least one polyethylene wax, with respect to the total weight of the composition (A), said wax having a viscosity comprised between 10 cPs and 1200 cPs measured according to the standard ASTM D3236 at 149° C. and a dropping point comprised between 107° C. and 120° C., measured according to the standard ASTM D3954.

Filler (I)

According to the present invention, the composition (A) comprises 10 to 40% by weight of at least one filler (I) or carbon black.

In the context of the present invention, said filler (I) can be any filler which could be used in a vulcanisation method. The term “filler” does not mean as long as the filler (I) is inert, indeed, the filler (I) can be a base, for example. It is also possible that the filler (I) can also play a role or not in the vulcanisation method.

Said filler (I) includes without being limited thereto: carbonates, alumina, silica, hydroxides, silicates, and mixtures thereof.

Carbonates can include alkaline earth metal carbonates, preferably the carbonates are selected from the group constituted of magnesium carbonate, calcium carbonate and mixtures thereof.

Hydroxides can include, without being limited thereto, alkaline earth metal hydroxides, preferably the hydroxides are selected from the group constituted of sodium hydroxide, magnesium hydroxide, calcium hydroxide and mixtures thereof.

Silica can include, without being limited thereto, silica fume or precipitated silica.

Silicates include, without being limited thereto, clays, micas, quartz, tridymites, cristobalites, feldspars, feldspathoids, zeolites, scapolites, serpentines, kaolinites and mixtures thereof.

Said at least one filler (I) according to the present invention is advantageously an alkaline earth metal carbonate, preferably a carbonate selected from the group constituted of magnesium carbonate, calcium carbonate and mixtures thereof.

Said at least one filler (I) can be present in the form of solid particles.

Said at least one filler (I) can have an average diameter D₅₀ of at least 500 nm, preferably at least 1 μm, more preferably at least 1.5 μm, even more preferably at least 2 μm. Said at least one filler (I) can have an average diameter D₅₀ of at most 10 μm, preferably of at most 7 μm, more preferably at most 5 μm, more preferably at most 3 μm.

In a particular embodiment, said at least one filler (I) can have an average diameter D₅₀ comprised between 500 nm and 10 μm, preferably between 1 μm and 7 μm, preferably between 1.5 μm and 5 μm, more preferably between 2 μm and 3 μm.

Said at least one filler (I) can have an average diameter D₉₀ of at least 5 μm, preferably at least 7 μm, more preferably at least 8 μm. Said at least one filler (I) can have an average diameter D₉₀ of at most 20 μm, preferably at most 17 μm, more preferably at most 15 μm, more preferably of at most 10 μm.

In a particular embodiment, said at least one filler (I) can have an average diameter D₉₀ comprised between 5 μm and 201 μm, preferably between 71 μm and 17 μm, preferably between 8 μm and 15 μm, more preferably between 8 μm and 10 μm.

Said at least one filler (I) can advantageously have a specific BET surface area comprised between 1 m²/g and 250 m²/g, preferably between 1.5 m²/g and 230 m²/g, more preferably between 2 m²/g and 200 m²/g.

In a preferred embodiment, when said at least one filler (I) is a carbonate selected from the group constituted of magnesium carbonate, calcium carbonate and mixtures thereof, said at least one filler (I) can have a specific BET surface area comprised between 1 m²/g and 10 m²/g, preferably between 1 m²/g and 5 m²/g, more preferably between 1 m²/g and 3 m²/g.

In another preferred embodiment, when said at least one filler (I) is silica, said at least one filler (I) can have a specific BET surface area comprised between 1 m²/g and 250 m²/g, preferably between 50 m²/g and 250 m²/g, more preferably between 100 m²/g and 200 m²/g.

The composition (A) comprises at most 40%, preferably at most 38%, more preferably at most 36%, even more preferably at most 35%, even more preferably at most 30% by weight of said at least one filler (I) or carbon black, with respect to the total weight of the composition (A). The composition (A) comprises at least 10% by weight of said at least one filler (I) or carbon black, preferably at least 15% by weight of said at least one filler (I) or carbon black, more preferably at least 20% by weight of said at least one filler (I) or carbon black, even more preferably at least 25% by weight of said at least one filler (I) or carbon black, even more preferably at least 30% by weight of said at least one filler (I) or carbon black with respect to the total weight of the composition (A).

In a preferable embodiment, the composition (A) comprises between 15% and 40% by weight, preferably between 20% and 38% by weight, more preferably between 25% and 36% by weight, even more preferably between 30% and 35% by weight of said at least one filler (I) or carbon black, with respect to the total weight of the composition (A).

Another aspect of the present invention relates to the use of said activating composition in a vulcanisation method.

The composition (A) can be obtained by a production method comprising at least one mixture step of, based on the total weight of said composition (A):
20% to 80% by weight of at least one vulcanisation activator [activator (V)];
10% to 40% by weight of at least one wax selected from the group constituted of paraffin waxes, microcrystalline waxes, polyolefin waxes, Fischer-Tropsch waxes, oxidised Fischer-Tropsch waxes, their derivatives and mixtures thereof;
10% to 40% by weight of at least one inorganic filler [filler (I)] or carbon black; said at least one activator (V), said at least one wax and said at least one filler (I) being in solid form, preferably in the form of powder or granules.

A person skilled in the art can use any means known from the state of the art to mix the activator (V), the wax and said at least one filler (I) or carbon black.

In a particular embodiment, the activator (V), the wax and said at least one filler (I) are mixed at the same time. In this embodiment, said at least one filler (I) can be replaced by carbon black.

In an alternative embodiment, the activator (V) is mixed with the wax in a first step so as to provide a first mixture. Said at least one filler (I) or carbon black is then added to said first mixture to form said composition (A).

Also, in another alternative embodiment, the activator (V) is mixed with said at least one filler (I) in a first step so as to provide a first mixture. Said wax is then mixed with said first mixture to form said composition (A).

Also, in another alternative embodiment, said wax is mixed with said at least one filler (I) in a first step so as to provide a first mixture. Said activator (V) is then mixed with said first mixture to form said composition (A).

Advantageously, said at least one mixture step is carried out at a temperature less than the dropping point of wax, preferably at a temperature comprised between 10° C. and 30° C.

Vulcanisation Method

As indicated above, the present invention also relates to a method for vulcanising a vulcanisable composition [composition (C)] comprising, with respect to the total weight of the composition (C), steps of:

providing said composition (C) comprising:

at least one vulcanisable polymer [polymer (V)] with between 2 and 10 parts by weight of said composition (A) with respect to 100 parts by weight of said polymer (V) and between 0.2 and 15 parts by weight of at least one vulcanising agent [agent (V)] with respect to 100 parts by weight of said polymer (V) to form said composition (C).

Heating of said composition (C) to a sufficient temperature and a duration adapted to this temperature to obtain a vulcanised composition.

According to the present invention, the term “vulcanisable composition” refers to a composition adapted to undergo a vulcanisation reaction such as described above.

The mixture of at least one polymer (V) and of said composition (A) can comprise other compounds, consequently said composition (C) can also comprise other compounds.

The step of heating said composition (C) can be carried out by means known to a person skilled in the art, like for example a heating press.

Preferably, said composition (C) can be heated to a temperature of at least 120° C., preferably of at least 140° C., preferably of at least 150° C., more preferably of at least 165° C. If desired, said composition (C) is heated to a temperature of at most 220° C., preferably of at most 200° C., more preferably of at most 180° C.

In a preferred embodiment, said composition (C) is heated to a temperature comprised between 120° C. and 220° C., more preferably between 160° C. and 200° C., even more preferably between 165° C. and 180° C.

The heating time of said composition (C) must be sufficient to obtain a vulcanised composition. A person skilled in the art can apply the heating times usually used in the state of the art.

Polymer (V)

The term “vulcanisable polymer” [below, polymer (V)] relates to any type of polymer capable of undergoing a vulcanisation reaction, namely which could be chemically cross-linked during this reaction.

The polymer (V) according to the present invention preferably comprises at least one monomeric unit having at least one unsaturation. The latter thus serves as an active site during cross-linking. Preferably, the polymer (V) comprises several unsaturations.

The polymer (V) can be, for example, a homopolymer, a copolymer or a terpolymer and can be obtained by Ziegler-Natta or metallocene-type polymerisation methods, without however being limited to the abovementioned polymerisation methods.

Preferably, the polymer (V) can be an elastomer. For example, the polymer (V) includes, without being limited thereto, natural rubbers, polyisoprene, butadiene styrene (SBR), polybutadiene, isoprene butadiene (IBR), the styrene-isoprene butadiene (SIBR), ethylene propylene/ethylene propylene-diene (EPDM), nitrile elastomers, propylene oxide polymers, star-branched butyl elastomers, halogenated star-branched butyl elastomers, bromine butyl rubber, chlorinated butyl rubber, cross-linked star polyisobutylene rubber, star-branched bromine butyl, copolymer rubber (polyisobutylene/isoprene), poly (isobutylene-co-alkylstyrene), preferably isobutylene/methylstyrene copolymers, such as isobutylene/meta-bromomethylstyrene, isobutylene/bromomethylstyrene, isobutylene/chloromethylstyrene, isobutylene cyclopentadiene and isobutylene/chloromethylene.

Preferably, the polymer (V) comprises a repetitive ethylene unit. Said polymer (V) preferably comprises at least 20% by weight, preferably at least 30% by weight, more preferably at least 40% by weight, even more preferably at least 50% by weight of said repetitive ethylene unit with respect to the total weight of said polymer (V). Said polymer (V) can preferably comprise at most 95% by weight, more preferably at most 90% by weight, even more preferably at most 85% by weight, even more preferably at most 80% by weight of said repetitive ethylene unit with respect to the total weight of said polymer (V).

In a preferable embodiment, said polymer (V) comprises between 20% and 95%, preferably between 30% and 90%, more preferably between 40% and 85%, even more preferably between 50% and 80% by weight of said repetitive ethylene unit with respect to the total weight of said polymer (V).

More preferably, said polymer (V) further comprises a repetitive diene unit. Said repetitive diene unit includes, for example, without being limited thereto, isoprene, butadiene, ethylidene norbornene, dicyclopentadiene, vinyl norbornene and mixtures thereof.

Preferably, the polymer (V) comprises a repetitive diene unit. Said polymer (V) preferably comprises at least 0.1% by weight, preferably at least 0.2% by weight, more preferably at least 0.3% by weight, even more preferably at least 0.4%, even more preferably at least 0.5% by weight of said repetitive diene unit with respect to the total weight of said polymer (V). Said polymer (V) can preferably comprise at most 25% by weight, more preferably at most 20% by weight, even more preferably at most 15% by weight, even more preferably at most 12% by weight of said repetitive diene unit with respect to the total weight of said polymer (V).

In a preferable embodiment, said polymer (V) comprises between 0.1% and 25%, preferably between 0.2% and 20%, more preferably between 0.3% and 15%, even more preferably between 0.5% and 12% by weight of said repetitive diene unit with respect to the total weight of said polymer (V).

In another particular embodiment, the polymer (V) is a terpolymer and comprises between 50% and 80% by weight of said repetitive ethylene unit and between 0.1% and 25%, preferably, between 0.2% and 20%, more preferably between 0.3% and 15%, even more preferably between 0.5% and 12% of said repetitive diene unit with respect to the total weight of said polymer (V), said repetitive diene unit being selected from the group constituted of ethylidene norbornene, dicyclopentadiene, vinyl norbornene and mixtures thereof.

In another alternative embodiment, it can be necessary that the polymer (V) has a percentage by lower weight of diene, in this case, the polymer (V) comprises between 0.1% and 10%, preferably between 0.2% and 9%, more preferably between 0.3% and 8%, even more preferably between 0.5% and 7.5% by weight of said repetitive diene unit with respect to the total weight of said polymer (V). In this case, the polymer (V) further comprises preferably between 20% and 95%, more preferably, between 30% and 90%, more preferably between 40% and 85%, even more preferably between 50% and 80% by weight of said repetitive ethylene unit with respect to the total weight of said polymer (V), said repetitive diene unit being selected from the group constituted of ethylidene norbornene, dicyclopentadiene, vinyl norbornene and mixtures thereof.

In another also alternative embodiment, it can be necessary that the polymer (V) has a greater percentage by weight of diene, in this case, the polymer (V) comprises between 1% and 20%, preferably between 2.5% and 17%, more preferably between 5% and 15%, even more preferably between 7% and 12% by weight of said repetitive diene unit with respect to the total weight of said polymer (V). In this case, the polymer (V) further preferably comprises between 20% and 95%, more preferably, between 30% and 90%, more preferably between 40% and 85%, even more preferably between 50% and 80%, even more preferably between 50% and 70%, even more preferably between 50% and 75%, even more preferably between 50% and 70% even more preferably between 50% and 65% by weight of said repetitive ethylene unit with respect to the total weight of said polymer (V), said repetitive diene unit being selected from the group constituted of ethylidene norbornene, dicyclopentadiene, vinyl norbornene and mixtures thereof.

The polymer (V) can further comprise a repetitive propylene unit.

The provision of said composition (C) comprising the mixture of at least one vulcanisable polymer [polymer (V)] with between 2 and 10 parts by weight of said composition (A) with respect to 100 parts by weight of said polymer (V). Preferably, the provision of said composition (C) can comprise the mixture of at least one polymer (V) with preferably between 2 and 8 parts by weight, more preferably between 3 and 7 parts by weight, even more preferably between 4 and 6 parts by weight of said composition (A) with respect to 100 parts by weight of said polymer (V).

Additional Component

Preferably, the step of providing said composition (C) can comprise a step of adding at least one additional component to said polymer (V). Said at least one additional component being selected from the group constituted of diatom earths, quartz, talc, glass filaments, graphite, carbon black, carbon nanotubes and mixtures thereof.

In a preferred embodiment, said at least one additional component is carbon black.

Oily Phase

Preferably, the step of providing said composition (C) can comprise a step of adding an oily phase to said polymer (V).

The oily phase if liquid at ambient temperature. Preferably, the oily phase is liquid at a temperature of −20° C., preferably −10° C., preferably −5° C., more preferably 0° C., even more preferably 5° C., even more preferably 10° C., even more preferably at a temperature of 15° C.

If desired, the step of adding an oily phase to said polymer can be carried out before or after said step of adding at least one additional component. Alternatively, the step of adding an oily phase to said polymer can be carried out simultaneously or at least partially simultaneously to said step of adding at least one additional component.

Fatty Acid

Preferably, the step of providing said composition (C) can further comprise the addition of at least one fatty acid.

In a preferable embodiment, the step of providing said composition (C) comprising:

a step of adding 0.2 parts to 5 parts by weight, preferably 0.5 to 3 parts by weight, more preferably 0.7 to 2 parts by weight of at least one fatty acid with respect to 100 parts by weight of said polymer (V) to form said composition (C).

If desired, said at least one fatty acid could be added to at least one polymer (V) or to said composition (A) before the mixture of said polymer (V) and of said composition (A). Alternatively, said at least one fatty acid can be added after the mixture of said polymer (V) and of said composition (A).

Examples of fatty acids include, without being limited thereto: stearic acid, lauric acid, oleic acid, palmitic acid and mixtures thereof.

Preferably, said at least one fatty acid can be selected from the group constituted of stearic acid, lauric acid, oleic acid, palmitic acid and mixtures thereof. More preferably, said at least one fatty acid is stearic acid.

Vulcanisation Accelerator

Preferably, the step of providing said composition (C) can further comprise the addition of a vulcanisation accelerator [accelerator (V)].

Any accelerator (V) usually used in the vulcanisation methods can be used. Generally, the accelerator (V) is selected from among the compounds capable of interacting with the activator (V) so as to reduce the time and/or the temperature of vulcanisation. Preferably, said accelerator is selected from the group constituted of amino aldehydes, guanidines, thiazoles, thiophosphates, sulfenamides, thioureas, thiurams, dithiocarbamates, xanthates and mixtures thereof.

Examples of amino aldehydes include, without being limited thereto: hexamethylenetetramine, products of heptaldehyde-ailine condensations and mixtures thereof. Examples of guanidines include, without being limited thereto: diphenyl guanidine, N, N′-diorthotolyl guanidine and their mixture.

Examples of thiazoles include without being limited thereto: 2-mercaptobenzothiazole, 2-2′-dithiobis(benzothiazole), zinc-2-mercaptobenzothiazole and mixtures thereof. A thiophosphate can, for example, be zinc-O,O-di-N-phosphorodithioate. Sulfenamides include, without being limited thereto: N-cyclohexyl-2-benzothiazole sulfenamide, N-tert-butyl-2-benzothaizole sulfenamide, 2-(4-morpholinothio)-benzothiazole, N,N′-dicyclohexyl-2-benzothiazole sulfenamide and mixtures thereof. Thioureas include, without being limited thereto: ethylene thiourea, di-pentamethylene thiourea, dibutyl thiourea and mixtures thereof. Thiurams include, without being limited thereto: tetramethylthiuram monosulphide, tetramethylthiuram disulphide, dipentamethylenethiuram tetrasulphide, tetrabenzylthiuram disulphide and mixtures thereof. Dithiocarbamates include, without being limited thereto: zinc dimethyldithiocarbamate, zinc diethyldithiocarbamate, zinc dimethyldithiocarbamate, zinc dibenzyldithiocarbamate and mixtures thereof. Xanthate can, for example, be zinc-isopropyl xanthate. In a preferred embodiment, said accelerator (V) is selected from the group constituted of mercaptobenzothiazole, tetramethylthiuram disulphide, N-cyclohexyl-2-benzothiazole sulfenamide, zinc dibutyldithiocarbamate and mixtures thereof.

In a more preferred embodiment, said accelerator (V) is a mixture of mercaptobenzothiazole, tetramethylthuiram disulphide, N-cyclohexyl-2-benzothiazole sulfenamide, zinc dibutyldithiocarbamate.

Preferably, at least 0.2 parts by weight, more preferably at least 0.5 parts by weight, even more preferably at least 1 part by weight, even more preferably at least 1.5 parts by weight of said accelerator (V) can be added with respect to 100 parts by weight of said polymer (V). If desired, at most 15 parts by weight, more preferably at most 12 parts by weight, even more preferably at most 10 parts by weight of said accelerator (V) can be added with respect to 100 parts by weight of said polymers (V).

In an embodiment between 0.2 and 15 parts by weight, preferably between 0.5 and 12 parts by weight, more preferably between 1 and 10 parts by weight, even more preferably between 1.5 and 10 parts by weight of said accelerator (V) can be added with respect to 100 parts by weight of said polymer (V).

Agent (V)

According to the present invention, the agent (V) is an agent allowing the vulcanisation of the polymer (V). Preferably, the agent (V) is adapted to react with at least one unsaturation of the polymer (V) so as to induce the cross-linking of the latter.

Examples of agent (V) comprise, without being limited thereto: sulphur, polysulphides, sulphur monochloride, sulphur dichloride, tellurium, selenium, thiurams, disulphides such as quinone dioximes, organic peroxides, di-isocyanates.

Preferably, the agent (V) is a sulphurous compound, and more preferably comprising at least one disulphide bond (S—S). More preferably, the agent (V) is a sulphurous compound selected from the group of sulphur, sulphur chlorides, polysulphides and mixtures thereof.

The inventors have demonstrated that to obtain a vulcanisable composition, the composition (C) must contain at least 0.2 parts by weight of an agent (V) with respect to 100 parts by weight of said polymer (V). Preferably, said composition (C) contains at least 0.3 parts by weight, more preferably at least 0.5 parts by weight, by weight of said agent (V) with respect to 100 parts by weight of said polymer (V).

The method according to the invention comprises a step of adding 0.2 to 15 parts by weight of at least one vulcanising agent [agent (V)] with respect to 100 parts by weight of said polymer (V) to form said composition (C).

In a preferred embodiment, the method according to the invention comprises a step of adding 0.2 parts by weight to 4 parts by weight, preferably 0.3 parts by weight to 3 parts by weight, more preferably 0.5 parts by weight to 3 parts by weight of said agent (V) with respect to 100 parts by weight of said polymer (V).

The agent (V) is advantageously added in the form of a powder to the composition (C).

According to the present invention, the term “powder” means any solid in the form of a powder, a granulate, fragments or any equivalent state which has an average particle size less than five millimetres (5 mm).

A last aspect of the present invention relates to a vulcanised composition obtained by the vulcanisation method according to the invention.

### EXAMPLES

The invention will now be described in more detail, based on the examples below, of which the aim is purely illustrative and not intended to limit the scope of the invention.

### Example 1—Composition (A)

The respective ingredients are mixed homogenously in a container where they have been weighed according to a defined ratio by weight.

Different compositions (A) have been prepared and are recorded in table 1 below. The quantities are expressed as percentages by weight with respect to the total weight of the composition (A).

TABLE 1
Composition (A)
Components of the composition (A)

| | Activator (V) | | |
|---|---|---|---|
| Composition (A) | ZnO | Wax | Calcium carbonate |
| 1 | 60% | 20% | 20% |
| 2 | 30% | 35% | 35% |
| 3 | 20% | 40% | 40% |
| C1 | 100% | / | / |

For all the compositions (A) of table 1, ZnO has a specific BET surface area comprised between 40 m²/g and 50 m²/g measured by adsorption manometry with a helium/nitrogen mixture (70/30) and calculated according to the BET (Brunauer-Emmett-Taylor) method, after degassing at 150° C. for at least 1 hour and a D₅₀ comprised between 200 nm and 300 nm.

The wax used is a polyethylene wax having a viscosity comprised between 10 cPs and 1200 cPs measured according to the standard ASTM D3236 at 149° C. and a dropping point comprised between 107° C. and 120° C., measured according to the standard ASTM D3954.

The calcium carbonate used has a specific BET surface area of 2 m²/g, a D₅₀ of 2.4 μm and a D₉₀ of 9.0 μm.

### Example 2—Vulcanisation Method

In a first step, carbon black (N550) and an oily phase being liquid at a temperature comprised between 15° C. and 30° C. are added to the EPDM (Vistalon™ 8800) in an internal mixer GK12 WP.

The mixture obtained is then worked for 2 minutes on a cylinder mixer.

Then, the composition (A) such as obtained in example 1 and the stearic acid are added to obtain a premixture. In this example, the compositions (A) 1 to 3 are used.

The premixture is then kneaded for 5 minutes during which accelerators and sulphur are added.

After measuring the rheology (see below) to know the vulcanisation conditions (among others, t90), the mixture is then moulded at a temperature of 170° C. for a time known to a person skilled in the art, for example t90 for the plates serving to produce test pieces for measurements of R/R, Mod 100 (see table 3) and t90+5 minutes for the pins serving to measure the DRC (see table 3).

The quantities used of the different components are stated in table 2.

TABLE 2
Composition (C)

| Compounds | Parts |
|---|---|
| EPDM | 100 |
| Carbon black | 80 |
| Oily phase | 50 |
| Stearic acid | 1 |
| Sulphur | 0.75 |
| Mercaptobenzothiazole (MBT) | 1.5 |
| Tetramethylthiuram disulphide (DTMT) | 1.5 |
| Cyclohexyl-benzothiazole sulphonamide (CBS) | 2 |
| Zinc dibutyl dithiocarbonate (ZDBC, CAS 136-23-2) | 2 |
| Composition (A) 1 to 3 of table 1 | 5 |

The composition (C) is prepared such as indicated in table 1. The quantities are expressed in parts, i.e. with respect to 100 parts of Polymer (V). The quantities of composition (A) are variable according to the examples.

When the composition (A) 1 to 3 (table 1) is used, it is observed that the mechanical properties are as good or very close in comparison, where 100% of ZnO has been used (Cl (comparison 1)). From this, it results that by using a reduced quantity of ZnO, the mechanical properties are at least as good (see table 3 below).

TABLE 3

| Mixture no. | C1 | 1 | 2 | 3 |
|---|---|---|---|---|
| Temperature (° C.) | 170° C. | 170° C. | 170° C. | 170° C. |
| Ts2 (min) | 1.1 ± 0.03 | 1.53 ± 0.1 | 1.15 ± 0.06 | 1.46 ± 0.04 |
| Cmax (dNm) | 14.77 ± 0.51 | 12.06 ± 0.24 | 12.63 ± 0.42 | 10.65 ± 0.67 |
| T90 (min) | 4.80 ± 0.68 | 5.80 ± 0.91 | 3.83 ± 0.77 | 4.18 ± 0.93 |
| R/R (Mpa) | 10.3 ± 0.6 | 9.6 ± 0.6 | 9.7 ± 0.5 | 10.7 ± 0.4 |
| All (%) | 269 ± 12 | 260 ± 8 | 290 ± 11 | 371 ± 15 |
| Mod 100 (MPa) | 3.6 ± 2 | 3.6 ± 0.1 | 3.3 ± 0.1 | 2.8 ± 0.2 |
| Hardness (Sh-A) | 63 ± 1 | 62.5 ± 1 | 62.5 ± 1 | 61 ± 1 |
| DRC 70 h at 100° C. | 36.5% | 37.3% | 37.9% | 36.6% |
| Tear (KN/m) | 123 ± 11 | 121 ± 4 | 126 ± 11 | 132 ± 5 |

The oscillating disc rheometer allows to determine the duration of a vulcanisation by measuring the start-up time of the vulcanisation (ts2) and of the time linked to the end of the vulcanisation (t90). The maximum torque (Cmax) measured during the rheological test allows to determine the values of ts2 and t90. The variation of the torques allows to give an indication regarding the cross-linking rate of the product obtained after vulcanisation. The maximum torque corresponds to measuring the vulcanised product (cured). Indeed, to maintain a stable oscillation of the disc of the rheometer both in frequency and in amplitude, the motor of the device provided what is called a variable torque. The latter depends on elasticity/viscosity of the product tested. Therefore, the more viscous or elastic the product is, the greater the torque is.

The measurements ts2, t90, Cmax, are taken with an oscillating disc rheometer according to the standard ASTM D5289 at a temperature of 170° C.

R/R (resistance to rupture), ALL (elongation), and Mod 100 (module at 100% elongation) have been measured according to the standard NF T 46-002.

DRC (deformation remanent to compression) at 25% has been measured according to the standard NF T 46-011.

The hardness measurements (hardness SH-A) have been taken according to the standard ISO7619-1 2010.

The tear measurements have been taken according to the standard NF T 46-007.

1. An activating composition for use in a vulcanisation method, comprising based on the total weight of said composition:
20 to 80% by weight of at least one vulcanisation activator;
10 to 40% by weight of at least one wax selected from the group consisting of paraffin waxes, microcrystalline waxes, polyolefin waxes, Fischer-Tropsch waxes, oxidised Fischer-Tropsch waxes, their derivatives and mixtures thereof,
10 to 40% by weight of at least one inorganic filler or carbon black.

2. The composition according to claim 1 comprising 20% to 50% by weight of said activator with respect to the total weight of said composition.

3. The composition according to claim 1, comprising 23% to 40% by weight, of said activator with respect to the total weight of said composition.

4. The composition according to claim 1, comprising 23% to 35% by weight of said activator with respect to the total weight of said composition.

5. The composition according to claim 1, wherein the activator is selected from the group consisting of zinc oxide, zinc hydroxide, zinc hydroxycarbonate and mixtures thereof.

6. The composition according to claim 1, wherein said at least one wax has a crystallisation point such that said at least one wax is solid at ambient temperature.

7. The composition according to claim 1, wherein said at least one wax has a dropping point between 25° C. and 130° C.

8. The composition according to claim 1, wherein said at least one filler is selected from the group consisting of carbonates, alumina, silica, hydroxides, silicas, and mixtures thereof.

9. The composition according to claim 1, comprising between 25% and 36% by weight of said at least one filler, with respect to the total weight of the composition.

10. The composition according to claim 1, comprising between 30% and 35% by weight of said at least one filler, with respect to the total weight of the composition.

11. The composition according to claim 1, comprising between 15% and 40% by weight of said at least one wax, with respect to the total weight of the composition.

12. A method for producing an activating composition according to claim 1, comprising at least one step of mixing, based on the total weight of said composition:
20 to 80% by weight of said at least one vulcanisation activator;
10 to 40% by weight of said at least one wax selected from the group consisting of paraffin waxes, microcrystalline waxes, polyolefin waxes, Fischer-Tropsch waxes, oxidised Fischer-Tropsch waxes, their derivatives and mixtures thereof,
10 to 40% by weight of said at least one inorganic filler.

13. A method for vulcanising a vulcanisable composition comprising, with respect to the total weight of the composition, steps of:
providing said composition comprising:
a mixture of at least one vulcanisable polymer with between 2 and 10 parts by weight of said composition, with respect to 100 parts by weight of said polymer, and
0.2 to 15 parts by weight of at least one vulcanising agent with respect to 100 parts by weight of said polymer to form said composition,
heating of said composition to a sufficient temperature and for a duration suitable for this temperature to obtain a vulcanised composition.

14. The method according to claim 13, wherein said polymer is selected from the group consisting of natural rubbers, polyisoprene, butadiene styrene, polybutadiene, isoprene butadiene, the styrene-isoprene butadiene, ethylene propylene/ethylene propylene-diene, nitrile elastomers, propylene oxide polymers, star-branched butyl elastomers, halogenated star-branched butyl elastomers, bromine butyl rubber, chlorinated butyl rubber, cross-linked star polyisobutylene rubber, star-branched bromine butyl, copolymer rubber (polyisobutylene/isoprene), poly (isobutylene-co-alkylstyrene), preferably isobutylene/methylstyrene copolymers, such as isobutylene/meta-bromomethylstyrene, isobutylene/bromomethylstyrene, isobutylene/chloromethylstyrene, isobutylene cyclopentadiene and isobutylene/chloromethylene.

15. The method according to claim 13, wherein, the step of providing said composition further comprises a vulcanisation accelerator.

16. The method according to claim 15, wherein, said accelerator is selected from the group consisting of amino aldehydes, guanidines, thiazoles, thiophosphates, sulfenamides, thioureas, thiurams, dithiocarbamates, xanthates and mixtures thereof.

17. The method according to claim 13, wherein the step of providing said composition comprises a step of adding at least one additional component to said polymer, said at least one additional component being selected from the group consisting of diatom earths, quartz, talc, glass filaments, graphite, carbon black, carbon nanotubes and mixtures thereof.

18. The method according to claim 13, wherein the step of providing said composition comprises a step of adding an oily phase to said polymer.

19. A vulcanised composition obtained by the method according to claim 12.

20. A vulcanised composition comprising, with respect to the total weight of the composition at least one vulcanisable polymer with between 2 and 10 parts by weight of said composition according to claim 1 with respect to 100 parts by weight of said polymer and of 0.2 to 15 parts by weight of at least one vulcanising agent with respect to 100 parts by weight of said polymer.
